(19) United States
(12) Patent Application Publication
(10) Pub. No.: US 2005/0275709 A1
(43) Pub. Date: Dec. 15, 2005

(54) Wire printer for printing additive color image

(76) Inventor: Kwan Ming Yung, Zheng Da Center (CN)

Correspondence Address: KWAN MING YUNG, 8F, BLOCK 7, ZHENG DA CENTRE, DONG GUAN CITY, GUANDONG, 523000, CN

(21) Appl. No.: 11/160,072

(22) Filed: Jun. 8, 2005

Related U.S. Application Data
(60) Provisional application No. 60/521,639, filed on Jun. 9, 2004.

(51) Int. Cl. B41J 2/435

(52) U.S. Cl. 347/224

(57) ABSTRACT

A device for printing additive color images comprising a modified desktop wire printer, a set of print wires with surface relief diffraction gratings incorporated at the tips, a steel print platen and a print substrate made of thermal plastic material, is disclosed. The striking strokes of the print wires impress a large plurality of tiny dot of diffraction gratings onto the substrate via the mechanism of micro embossing to form the image. Color differentiation is accomplished by varying the pitches of the diffraction gratings in the dots. An alternating technique of transfer printing to produce similar result is also disclosed.

### BACKGROUND OF INVENTION

(1) Field of the Invention

The present invention relates in general to color image printing, and more particular to a new desktop printing device that is capable to print color images using additive method. The image thus printed may have three-dimensional features.

The printing process embodying the present invention is performed by mechanically impressing a plurality of non-overlapped dotted diffractive optical elements onto a thermoplastic recording medium via the micro-embossing mechanism, with the help of a modified wire printer. The latter is incorporated with surface-relief pattern of diffractive optical elements at the wire tips.

(2) Classical Art

All the printing devices available nowadays in the market such as computer desktop printers, silk-screen printing, off set printing, etc. employ a subtractive method for printing color images. This is done by applying the colorant in the form of paints or inks onto printing substrate such as canvas or paper. These colorants contain fine solid particles called pigment that absorb a portion of the incident light while the other spectrum are reflected off the substrate to reach the eye. For example what happens to the light illuminating onto a blue paint on a white paper is that the pigment absorbed all sort of spectrum in the incident light other than the blue. The remains of the light, blue light, are not absorbed and are reflected into the eye.

There are three primary colors for the subtractive printing method, namely cyan, magenta and yellow. These are also called process red, process green and process blue respectively. In reproduction, these colorants are presented on the prints as dots of different size. The colors corresponding to different colorants are actually mixed in our eyes, not in the ink. When these CMY colors are combined they produce black color. But for reasons of impurity in the colorant they cannot give a black color that is black enough. Therefore the fourth colorant, namely black, is added to complete the full color printings of CMYK.

On the other hand, the common displaying devices such as TV, computer monitors, liquid crystal displaying screens and movie can provide additive color images, by mixing colored lights. In these devices colors are presented in the form of non-overlapping mosaic of red, green, and blue dots of light, which are also called the three primary colors. The completely mixing of them gives white color. At normal viewing distances the eye does not distinguish the dots, but blends or adds their stimulus effects to obtain a composite color. For example in a full color monitor driven by a 24 bit video card, each of the primary colors is displayed at 256 level of intensity. That means more than 16.7 millions (256×256×256) colors can be obtained.

(3) Prior Art

Printing methods using additive colors are found in color slides (sometimes called color reversal or color transparency) in photography and in hologram. Color marking engines capable of printing non-overlapping additive colorants such the Kodak Imagesource 70C/P electrophotographic color printers are known. Another common type belongs to the category of embossed rainbow hologram, which is in fact providing a well-developed technology for additive color printing on a reflective substrate such as aluminized polyester foil. However the latter requires sophisticated equipment, laser and optics in the manufacturing process, making it obviate from being populated into a widely applicable means of printing.

There are intrinsic differences in appearance of the color images printed by the two different methods. In general the additive method gives a vibrant and brilliant effect while the subtractive method provides images that looks dull. Technically speaking the additive method can produce up to 16.7 million colors while the subtractive print can reproduce only 5,000 to 6,000 colors. Unfortunately for technical reasons most of the printing available nowadays are produced using the undesirable subtractive method.

(4) Related Art

This invention combines the useful aspects of several existing technologies, e.g. embossed holography, ion mill etching and most important the wire printing to form one single and compact printing apparatus. The applications of these existing technologies have been well established in their respective fields and their associated products have been widely used. Therefore all the equipment and technology involved in this invention is readily obtainable in the market, presenting no technical or economic barriers to the implementation of the apparatus. Those technologies in the related art that makes substantial contribution to the present invention are discussed in the following. Since these technologies are well known and well established already, it is therefore not intended to provide a thorough review here, but rather only to provide a background sufficient to orient one skilled in the art enough to fully appreciate the present disclosure.

Also in order to provide a comprehensive disclosure without unduly lengthening the specification, a printing system involving three primary colors of red, green and blue is chosen as an example in the printer disclosed herein. It is however not intended to limit the number of colors making up the color image in the present invention, say for example the seven coloration system of pink, red, orange, yellow, green, purple and blue can also be adopted.

(A) Embossed Hologram

The mechanism that is employed in embossed holography plays a major role in the present invention. This type of hologram exhibits brightness and color variation with three-dimensional effects and most important, is white light viewable. Embossed rainbow holography provides means of printing a vast amount of holograms at high speed and in low cost. It is at present widely used in the field of security and promotional labels. Its other major application is in the area of decorating and packaging art. The interference pattern that is recorded in an embossed rainbow hologram is of surface-relief type. Physically there record a large plurality of crises-cross interference lines superimposed onto each other on the surface of the hologram. The production method is discussed in the following.

Referring to the flow chart in FIG. 1A the process involves first making a master hologram in the form of surface-relief interference pattern on a glass plate coated with positive photoresist. Optical set-up using lasers and isolating table is required in this mastering stage. After the holographic exposure is made the plate is developed and then used to form a metal master of the surface relief pattern by electroforming.

The images on the nickel master (printing shim) are then replicated in large volume at high speed onto aluminized polyester foil under the conditions of high temperature and pressure using the embossing machine. The most common operation mode of the machine is the roller type as shown schematically in FIG. 1B. The printings shim 101 bearing the surface-relief pattern of the hologram is being pressed against the aluminized polyester foil 102 by two hardened steel-rollers 103 and 104. The pressure and temperature involved in the embossing interfaces is about 5 tons per square inch and 250 Degree F. respectively.

Another method in performing the embossing procedure in the prior art is the planar mode as illustrated in FIG. 1C. The nickel printing master 101 is mounted onto a planar head 105 made of hardened steel and is in turn being pressed by a hydraulic press 106 at a temperature of around 250 degree F. and a pressure of 5 tons per square inch against a substrate 107. The latter is normally made of thermoplastic material such as acrylic or polycarbonate. This is a known and well-established technique in the art and is alternatively called mechanical recombination or stamping. Its function is to repeatedly stamp the image from a small master onto a larger format.

In short the roller form embossing configuration is used for the mass duplication of the holographic labels while the planar form is used to produce a master of large format containing the plurality of small images. It is the microscopic version of the planar form of embossing technique that contributes to the printing mechanism employed in the present invention.

(B) Wire Printer

In the field of high-speed printing in connection with computer data processing systems there are basically three types of printer that are most commonly used, e.g. the wire printer, the ink jet printer and the laser printer. Amongst them the oldest type is the wire printer or sometimes called the matrix-styli printer, in which the image is formed from a series of dots produced by the impact of a plurality of printing wires at elevated pressure and temperature onto a recording medium via an inked ribbon. The ribbon normally contains wax-based colorants and therefore requires an elevated temperature at the wire tips to transfer the ink onto the paper substrate.

FIG. 2A is a perspective view showing schematically the construction of a conventional wire printer 201. The apparatus comprises the printing head 203 that is supported on a carriage rail 202 and the former is in turn caused to traverse a line of movement across the recording medium 204 that is normally a piece of paper. During printing operations the wires 205 are driven by electromagnets 206 and strike onto the ribbon against a hard-rubber platen 207 over which the recording medium 204 is being supported.

A recording-medium feeding device 208 comprising two rollers and a stepping motor (not shown) mounted downstream of the printing head for causing the recording medium to make a timed movement of advance. As the carriage 202 shifts the printing head through successive columns along a line of movement horizontally, a dot pattern of images 209 is produced on the recording medium. This process is accomplished by selective displacement of individual printing wire in their successive column positions for impacting the recording medium through the inked ribbon (not shown) placed in front of the wires in accordance with the control signals of the computer.

FIG. 2B shows a side view of a printing head 203 inside which the plurality of wires 205 together with the driving solenoids 206 are being housed in a closely packed manner. FIG. 2C shows a schematic view of the unit of print wire 205 and solenoid 206. One end of the wire 205 is attached to the solenoid while the other end (hereinafter called the tip) is free to move in a direction perpendicular to the printing substrate. The solenoid comprises a permanent magnet 207 and a coil 208. During printing the print wire is driven with a forward stroke of about 0.5 mm from a rest position to an impact position and is then returned by a leaf spring 209.

The wires are made of tungsten and take the form of thin and long styli having a length of about 2.5 cm and a diameter of 0.25 mm. The wires are kept space apart in a matrix format. There is a plurality of such solenoid-wire units being fit into the print head 203. Typical configuration of the wire arrangement is illustrated in the perspective view of the print head 203 in FIG. 2D. The plurality of wires 205 is arranged in such a manner that they are located equidistantly from one another in two columns at the center of the printing head. There are normally 9 or 24 sets of wire/solenoid housed in the printing head of the wire printer as available in the commercial market. For more information about such methods, see U.S. Pat. Nos. 3,955,049 and 4,136,978 that are incorporated by reference herein. Nowadays the wire printing technology providing high quality printing at high speed is readily available, with an image resolution up to 360 dpi at a printing speed of 4500 impacts per second per wire.

To facilitate the transfer of the wax-based ink from the printing ribbon onto the printing medium the temperate in the printing head is normally elevated to a certain extend. This intrinsic nature of the provision of heat and pressure of the wires in the wire printer makes it to be a good candidate to perform the function of micro embossing as required in the present invention. Namely the hammering force exerted by the wire together with the elevated temperature provides the necessary machinery for the dotted-embossing mechanism.

(C) Ion Mill Etching

Ion milling etching is a process in which a stream of ion is used to bombard and remove the atoms from the substrate material. The transfer of momentum from the incident ions to the target atoms on the substrate achieves etching. The ion stream is produced by a gas-plasma, usually argon, which is being excited either by radio frequency or direct current. The target substrate is put inside a milling chamber and the ions are focused and accelerated toward the target by the negatively biased grid network.

The advantages of using ion mill are that (a) the etching is highly directional; (b) photoresist can be used as a masking material for pattern delineation and (c) the substrate can be tilted to perform etching at an angle to produce grazing angle surface profile. Alternate methods to achieve similar etching effects are RF sputter etching, plasma etching, and reactive sputter etching. FIG. 3 illustrates the flow diagram regarding the operation process of the ion mill etching employing photoresist as a mask. For more information about such a method, see U.S. Pat. No. 5,035,770 granted on Jul. 30, 1991 to Braun et al.

Surface-relief diffractive optical elements incorporated onto a metallic substrate as produced by the aforementioned optical and electroforming technique normally have a sinusoidal waveform in the cross-sectional profile. A further process of this sinusoidal profile using the ion mill etching method with the grating surface being bombarded by the ions at an angle may change the surface-relief gratings on the substrate from a sinusoidal profile to a glazing angle one. The latter offers better brightness to the diffracted light and therefore the surface-relief diffractive optical element incorporating at the wire tips as depicted in the present invention is made using this ion mill method.

The ion mill etching technique plays an important role in the present invention as it provides a means to incorporate a durable surface relief pattern onto the tip of the wire that is made of tungsten.

### SUMMARY OF INVENTION

This invention provides an apparatus and method to satisfy the long desired need in the market, namely a desktop computer printer that is capable of printing additive color images on plane substrates made of polyester or Polycarbonate. The technical advantage of the present invention is that it offers printed images with the same vibrant and brilliant color effects that are otherwise obtainable only in large size electronic displaying devices such as televisions and computer monitors.

According to one aspect of the present invention, there proposes to use the mechanism of a conventional desktop wire printer to perform the job of additive color printing. No ink or paint, no laser or lens are involved in the printing process. Instead colorants are replaced by dots of diffractive optical element that are being embossed onto the substrate surface. Each optical element provides color information corresponding to a microscopic image plane rainbow hologram. The plurality of diffractive optical elements that are embossed onto the substrate are so arranged as to exhibit an image comprising three primary colors of red green and blue when viewed from a fixed angle.

In this invention a plurality of printing wires incorporated with surface relief diffractive optical elements at the wire tips of a wire printer are driven to strike onto thermal plastic substrates. The heat and force associated with the wire in the striking action performs a micro-embossing process to transfer the surface relief pattern onto the substrate such as aluminized polyester foil to produce the necessary color effects. Three optical elements each bears one of the three primary colors of red, green or blue are used. The application may extent to the use of seven colors to represent directly the color combination of the image.

The possibility for an immediate success in implementing the present invention relies on the provision in making direct analogy to the known technique of embossed holography: (1) The force and heat associating with the wire that is built-in intrinsically in the printing action of a conventional wire printer mimics the function of embossing machines in a microscopic version. (2) The surface relief diffractive optical element incorporated at the tip of the print wire acts exactly the same as the printing shim in embossed holography. (3) Thermal plastic materials are used as printing substrates to complete the analogy to an embossed holographic system. This invention opens the gateway to a wide variety of applications in the field of additive color image printing for the publishing and desktop computer printing industries.

In the consideration of the foregoing discussion it is therefore the objects of the present invention:

(1) To realize an additive color printing apparatus that does not use colorants, laser or lenses but employs an electromechanical means of micro embossing mechanism to impress the plurality of dot-shape diffractive optical elements having multi-colors onto the printing substrate.

(2) To realize an apparatus for additive color printing system provided with a set of parameter regarding the impacting force, time duration and temperature of the wire in the wire printer for it to perform the proper function of micro embossing.

(3) To provide a means to incorporate the surface relief diffractive optical element onto the tip of the printing wire so as to provide with a durability and longevity of performing billions of impacts over its lifetime.

(4) To provide a print head with an array of printing wires capable to print images of multiple colors having a large variety of intensity level.

(5) To provide a printing head with wires arranged in a matrix format to optimize the resolution of the image.

(6) To provide print wire with tips having different size to optimize the intensity distribution of the image.

(7) To provide print wire with tips having conical profile to allow adjustable dot size to the image.

(8) To provide a printing head with solenoid having variable driving current to adjust the impacting force in the wires.

(9) To provide appropriate materials for uses as printing substrate.

(10) To provide a print platen allowing appropriate support to the print substrates.

(11) To provide print masters for the mass production of additive color printing in the publishing industry.

(12) To provide an alternating method of additive color printing using foil-transfer and pressure activated printing substrates.

### BRIEF DESCRIPTION OF DRAWINGS

The invention can be more fully understood by reading the following detailed description of the preferred embodiments, with reference made to the accompanying drawings.

FIG. 1 illustrates the process of making embossed hologram in the related art, wherein (A) is the flow diagram, (B) is a roller-type embossing configuration and (C) is a planar-type embossing configuration.

FIG. 2 illustrates the construction of a conventional wire printer in the related art wherein (A) is a schematic diagram of the constituent parts; (B) is an exposed view of the printing head assembly; (C) shows one of the wire-solenoid unit and (D) is a perspective view of the printing head.

FIG. 3 is a flow diagram illustrating the process involved in the ion mill etching technique in the related art.

FIG. 4 is a block diagram illustrating an additive color printing system employing the present invention.

FIG. 5 is an optical arrangement for the construction of a diffractive optical element to be incorporated at the tip of the print wire according to the present invention.

FIG. 6 (A) is an enlarged side view of a print wire and (B) is the elevated view of the print head illustrating the arrangement of the wires of various sizes in a matrix format according to an embodiment of the present invention.

FIG. 7 is an enlarge view of a portion of the image printed by the additive color method according to the present invention.

FIG. 8 is a schematic diagram illustrating the structure of the recording medium embodying the present invention wherein (A) is an aluminized polyester film and (B) is a board of polycarbonate.

FIG. 9 is a flow diagram illustrating the procedures as a preferred embodiment of the present invention in preparing the print master for mass replication of additive color images in the publishing industry.

FIG. 10 shows an alternate method for additive color printing in the present invention using a conventional wire printer with ribbons made of transferable diffraction foil wherein (A) is an elevated view of the print head and the ribbon; (B) is an enlarge view of a print wire and (C) is an exposed view of the cassette and ribbon.

FIG. 11 shows an alternate method for additive color printing of the present invention using a conventional wire printer wherein (A) is the cross sectional structure of the transfer (stamping) foil; (B) is the cross sectional structure of the print substrate and (C) illustrates the mechanism of image transfer.

FIG. 12 shows an auxiliary illuminating device for the purposes of facilitating the proper viewing of the additive color image in the present invention wherein (A) is the side view and (B) is the perspective view.

FIG. 13 is a schematic diagram of a control chart for guiding the viewer to locate the correct viewing configuration.

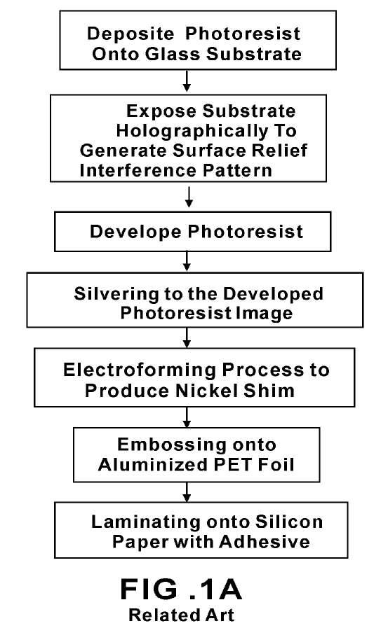

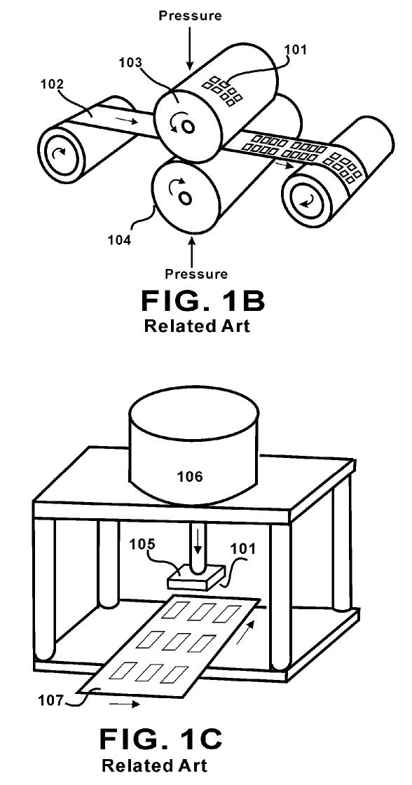

### DETAILED DESCRIPTION

The objects, features and advantages of the present invention will be more clearly understood and appreciated from the following detailed description of the preferred embodiments and features.

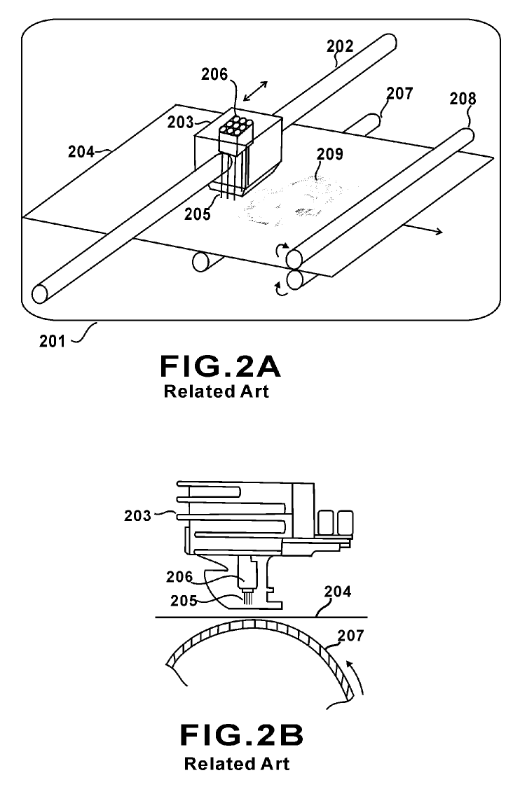

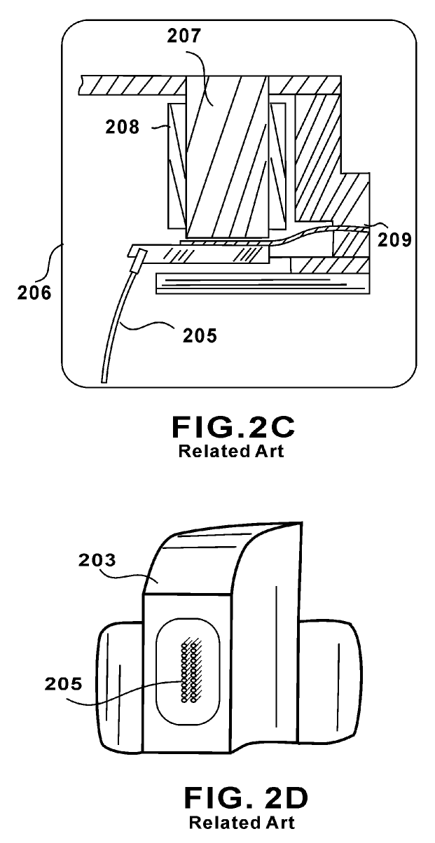

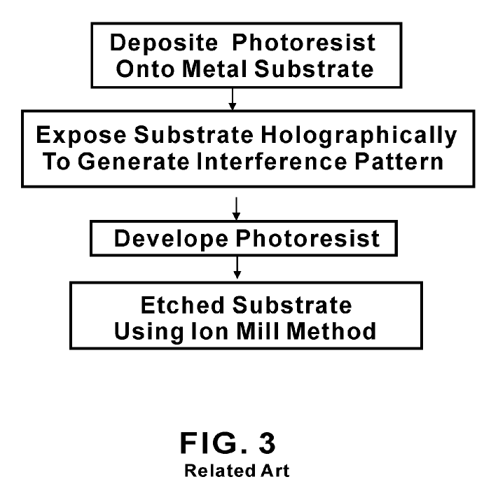

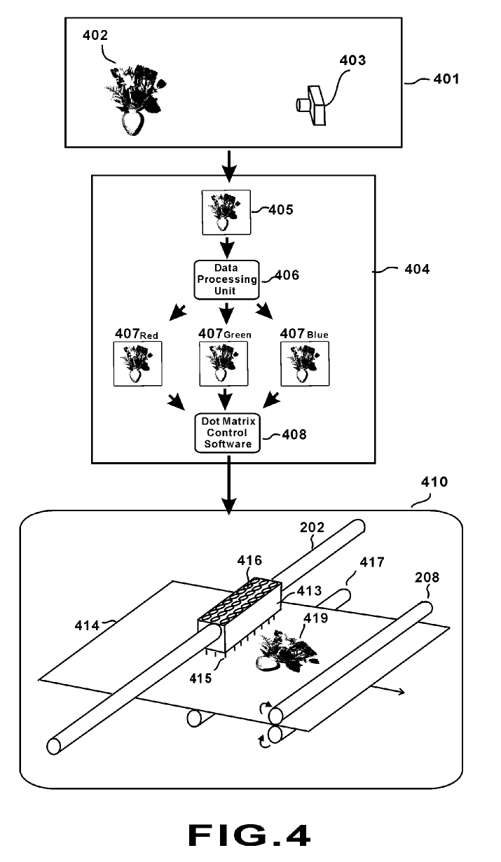

Referring particularly now to the block diagram in FIG. 4 illustrating the system embodying the present invention. It comprises (a) a color-image shooting device 401, (b) a data processing and controlling computer 404 and (c) a modified wire printer 410. The unit of 410 is similar to the ones shown in FIG. 2 and therefore its detailed description will be omitted except for those areas of difference. The like parts to the previous description are designated by like reference numerals in the diagram.

In this system a color photo 405 of the real object 402 is first recorded using the digital camera 403. The data is then analyzed and color separated by the data processing unit 406 into a plurality (n. times. m) of pixel blocks (e.g. 1024. times 0.786 pixels) to generate digital image data files of 407Red, 407Green and 407Blue in the format of 8-bit pixels in half-tone configuration. In each pixel block, pure color pixels (fully saturated red, green, blue, black) are identified and assigned to print with the corresponding print wire bearing the colored diffractive optical elements. Black color is effected in those areas on the print substrate where there is no printing action has taken place.

The unit 408 provides at least four operating controls to the printing process; these are (a) to allow exact registration for the printing of an image element with respect to its corresponding wire having appropriate colors, (b) to allocate appropriate current to the driving solenoid to alter the striking force of the wire. This results in variation of dot-sizes in the print and thus provides with the mechanism of printing different color intensity, (c) to controls the movement of both the printing head and the recording medium, and (d) to coordinate other components of the printer in accordance with the colors and intensity of the images to be printed.

In accordance with the present invention, the additive color printer 410 disclosed herein is basically similar to the conventional wire printer described above in FIG. 2. But there are at least seven major areas of modification: (a) the cassette and inked ribbon are removed; (b) the tip of the wires are made to have different diameters; (c) the tip of the wire is etched with patterns of surface relief diffractive optical elements; (d) the tip of the wire is made to have a conical surface profile; (e) the solenoids are provided with variable electrical currents to alter the impacting force of the wire; (f) a film of thermoplastic material is used to substitute the paper as printing substrate; (g) the soft rubber platen backing the printing substrate is replaced by a roller platen that is made of steel.

Now the description will be oriented to describe the modification to the conventional wire printer 201. According to a preferred embodiment of the present invention, the use of inked ribbon is abandoned but instead to employ specially constructed print wires 415 that have been etched with patterns of surface-relief diffractive optical element at the tips. Three sets of wires are used; each set corresponds to one of the three primary color of red, green and blue. For each printing stroke the wire 415 strikes and transfers the pattern of the surface relief diffractive optical element at the wire tip onto the thermal plastic printing substrate 41 4 via the mechanism of micro embossing.

According to another aspect of the present invention, the tip of the wire etched with the surface relief pattern is made to have a convex surface profile. The radius of curvature of this profile is at least five times larger than the diameter of the individual wire. The wire having a conical profile at the free tip may indent a concave impression on the substrate surface.

A further modification to the conventional wire printer is that the electrical current supplying to the driving solenoid 41 6 has a variable value in accordance with the brightness of the dot image to be printed. This current affects the impacting force of the wire, e.g. the larger the striking force the larger is the diameter of the indentation area of the optical element that is created and the brighter is the diffracted light.

These particular features of having (a) a convex surface at the wire tip and (b) a variable driving current in the solenoid work together to allow for the creation of a series of variable dot size in the indentation. Different dot size mimics the effect of difference in the diffracted light intensity, thus providing different brightness to the image.

Yet another aspect of the invention is to provide a plurality of wires having different diameter at the wire tips. Given the condition that the various wires are driven with the same pressure, those with larger diameter may create a larger indention and hence offer a brighter image.

When work together, the three modifications to the print head of the conventional wire printer, namely the difference in diameter at the wire tips, a conical wire tip profile and variable driving current to the solenoids, are capable to print images having at least 8-bit (256) of intensity levels to the diffracted light for each color.

The striking force and temperature of the wire should be appropriately adjusted to deliver the necessary force and heat to form dotted image on the substrate. The final image 419 thus made bears a large plurality of non-overlapping diffractive optical elements with different dot size and colors. In a modern wire-printing machine, each printing stroke is completed within a few thousandth of a second. Therefore it may take only a few tens of second to complete one image at the size of A4.

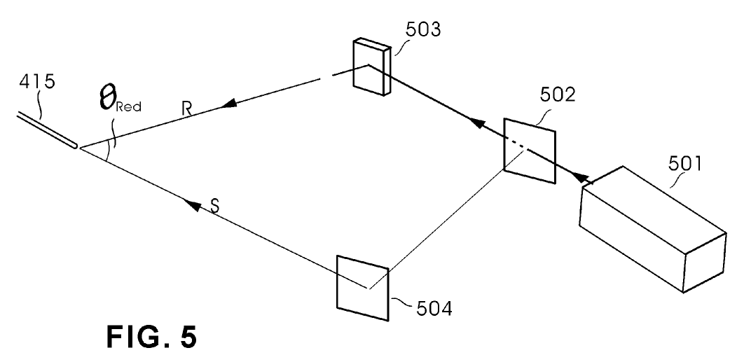

The production method of the diffractive optical element that is incorporated at the wire tip for use to print the three primary colors embodying the present invention is now discussed. Reference is made to the optical apparatus of double beam interference in FIG. 5. The wire tip 415 is first polished to produce a surface with optically smooth and semi-spherical profile, and is then coated with a thin layer of positive photoresist. The wire and the optics are mounted on a vibration isolation table. The laser beam 501 corresponding to a Helium-Cadmium laser is divided into object 504 and reference 503 beams by the variable beam-splitter 502. The two beams are then brought to interfere with each other at the tip of the wire. Variation in colors is obtained by changing the angle Theta between the object and reference beams appropriately. The angle for making red color spectrum is smaller than that for green color.

After chemically developing the exposed photoresist, that is now bearing a surface relief profile of interference pattern, the wire is put inside an ion mill chamber and bombarded by ions to remove part of the metallic material in accordance with the profile in the diffractive optical element. The amount of metallic metal that need to be removed is very minimal, by way of example a typical wire having a diameter of about 0.1 mm and a length of 5 cm will have an average depth of 0.5 micron in the relief pattern of the diffractive optical element.

The diffractive optical element thus obtained provides a plane distribution of rainbow color and does not provide with any depth perception. This optical element diffracts various colors of light within the visible spectrum when viewed from different angles.

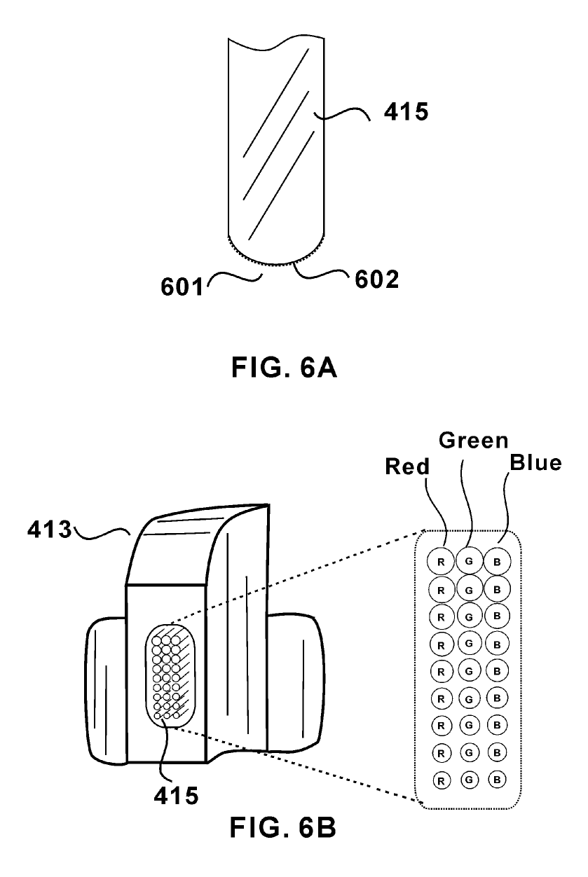

It is preferable, though not necessary, to use grazing angle surface relief pattern for making the diffractive optical elements at the wire tip. During high-speed printing the contact interval between the wire and the print substrate is relatively short. With such a short moment of encounter the heat in the wire may not be able to transfer into the print substrate efficiently and sufficiently. Therefore a surface-relief pattern in the wire tip with grazing angle micro profile can help to facilitate and enhance the embossing process. This feature is achieved by bombarding the photoresist image recorded on the metal substrate of the wire tip with ion beams at an oblique angle during the ion mill etching process. FIG. 6A shows an enlarge side view of the tip portion of a print wire 415 that is etched with surface relief pattern of the diffractive optical element 602 using ion mill technique. It also illustrates the semi-spherical profile 601 at the wire tip.

Another embodiment of the present invention is to assemble the wires into the housing of the printing head 413 as illustrated in the elevated view in FIG. 6B. All the driving solenoids, heating elements and wires are housed inside the body of the print head. When in resting position the wires are protruded outside of the print-head body for about 0.5 mm. The printing ends of the wires 415 are arranged in a closely packed manner within a block of matrix having 3×8 elements. The choice of 3×8 format is purposely to include the three primary colors each having 8 pieces of wire with different diameter. Other formats such as 7×4, 7×8 etc., can also be adopted.

The force and heat delivered by the wires during the short impact duration should be adjusted to be just sufficient in performing the embossing function of transferring the surface-relief pattern at the tip of the wire onto the substrate. Too large a force may create unnecessary geometrical distortion to the planar surface of the print substrate. The dots of diffraction pattern contributing to the color images do not physically overlap but are exclusive from each other. By making the dots size small enough visual images produced by them can provide an overlapping and continuous appearance.

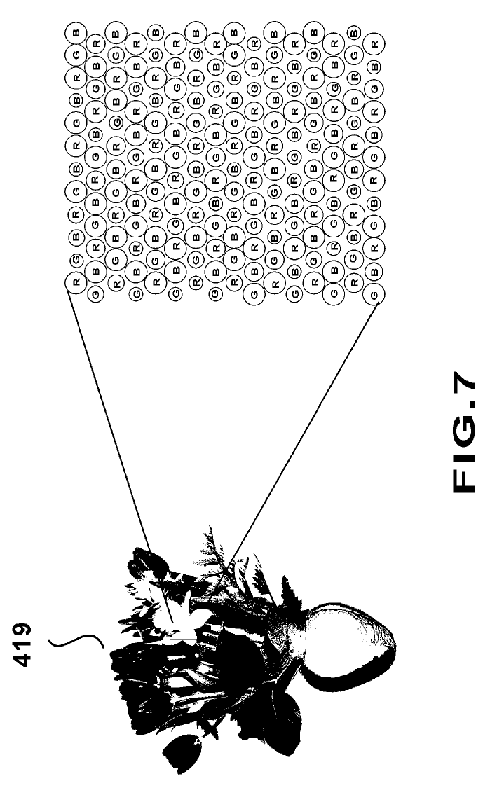

The color image is being built-up in a dot-by-dot, line-by-line and column-by-column manner by selective actuation of the wires in combination with a respective movement of the printing head carrier and the advance movement of the substrate. A diagram showing the enlarge view of a portion of the color image 419 thus printed is illustrated in FIG. 7, in which the mechanism of building up the color image using the various color and size of dots is clearly shown. Basically the tri-dots arrangement of red, green and blue similar to that used in color monitors is adopted.

A further embodiment of the present invention is now disclosed. The roller platen 207 opposite to the printing head in a conventional wire printer is normally made of rubber, which is therefore not hard enough to provide appropriate support to the PET foil from indentation that is given rise by the shear amount of impacting force of the wires. It is therefore necessary to replace the rubber roller to one 417 that is made of steel. An alternate method is to put a piece of thin board of acrylic behind the PET foil during the printing process. Otherwise the planar geometry of the optically smooth reflective surface of the printing substrate will adversely be distorted.

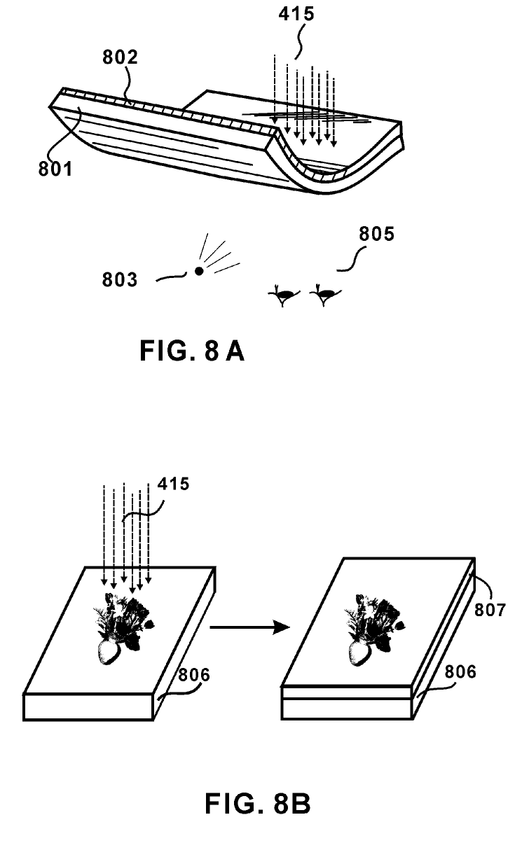

Another preferred embodiment of the present invention is to provide appropriate printing substrates to carry the prints. This substrate is preferable to have a flat and mirror-like surface on which a relief pattern of diffractive optical elements is mechanically transferred. It is preferably to be fabricated from thermoplastic materials with excellence in transparency such as polyester, polycarbonate or acrylic. By way of example the cross-sectional view of a typical substrate, e.g. an aluminized polyester foil having a thickness of about 25 to 50 micron is shown in FIG. 8A. One of its two faces is coated with 0.02 micron thick of aluminum 802 by method of vacuum sputtering to provide reflection to the incident light 803. The micro-embossing process made by the impact of the wires 415 is performed on the aluminum side 802 while the observer 805 views the color image from the clear and transparent side. The latter provides a window for the viewing of the image and also acts as a protection coating.

Another material that can be used as printing substrate is polycarbonate, which is by nature very clear and transparent having a mirror-flat surface and therefore becomes a good candidate for use in the present invention. FIG. 8B shows the printing configuration on a polycarbonate plate 806 having a thickness ranging from 0.5 to 1 mm. After the printing is made a thin layer of silver 807 is coated onto the side of impact to enhancing the image.

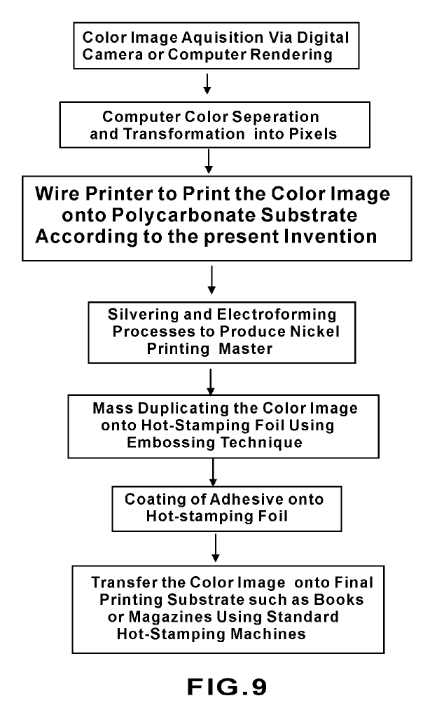

The use of polycarbonate as print substrates has a signification application for the present invention since it can be used as print masters in the publishing industry, thus provides with a means for mass production of the additive color images. The detail of such a system is now discussed and is referring to the flow diagram in FIG. 9. To make a print master the surface-relief pattern of the additive color image printed on the polycarbonate substrate is first subjected to silvering and electroforming processes. The nickel print master thus created is then used to replicate by embossing the color image onto the aluminized polyester hot-stamping foil in large volume at high speed. The image in the hot stamping/transfer foil is then transferred into the final substrate such as books and magazines using standard hot-stamping printing machinery. For this application a flatbed type of wire printer is preferable because the polycarbonate board of 0.5 mm thick is not easily bendable to pass through the rollers in the roller type wire printer.

Yet another alternate method embodying the present invention in which an additive color printing apparatus comprising a wire printer and a ribbon cassette is disclosed. This time there is no surface-relief diffractive optical element etched onto the tip of the wire. Instead the diffractive optical element is incorporated into the ribbon. Namely a conventional wire printer is used with the inked ribbon inside the cassette replaced by a foil made of transferable materials. This transferable foil is imprinted with three files of surface relief diffraction pattern corresponding to the three primary colors of red, green and blue. The three sections are arranged in long strips adjacent closely to each other and are imprinted on one single web of continuous foil.

In contrast with the primary embodiment of the present invention, in which the wire printer is converted to perform as a micro-embossing machine, this time the wire printer plays another role to function as a micro-stamping machine. The mechanism of image transfer is completed by the contribution of special characters in both the transfer foil and the substrate material. The latter is coated with pressure-activated adhesive.

In accordance with this embodiment the alternate additive color printing apparatus disclosed herein is similar to the wire printer discussed above in FIG. 2. But there are at least five major areas of modification: (a) the inked ribbon is replaced by a web of transferable diffractive foil; (b) the tip of the wires are made to have different diameters (c) the tip of the wire is optically polished and has a semi-spherical profile; (d) the driving solenoids are provided with variable electrical currents to alter the impacting force of the wire; (e) a film of polyester coated with pressure activated adhesive is used to substitute the paper as printing substrates.

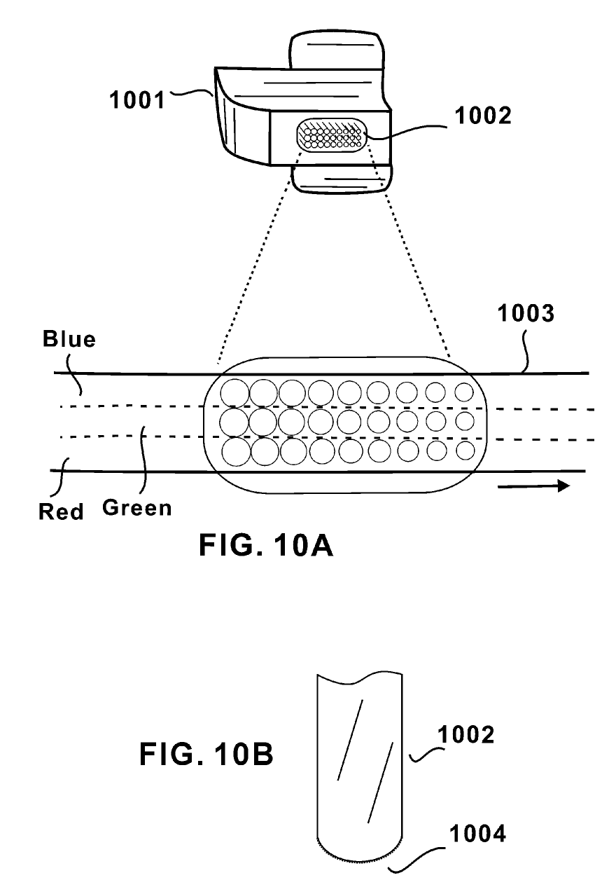

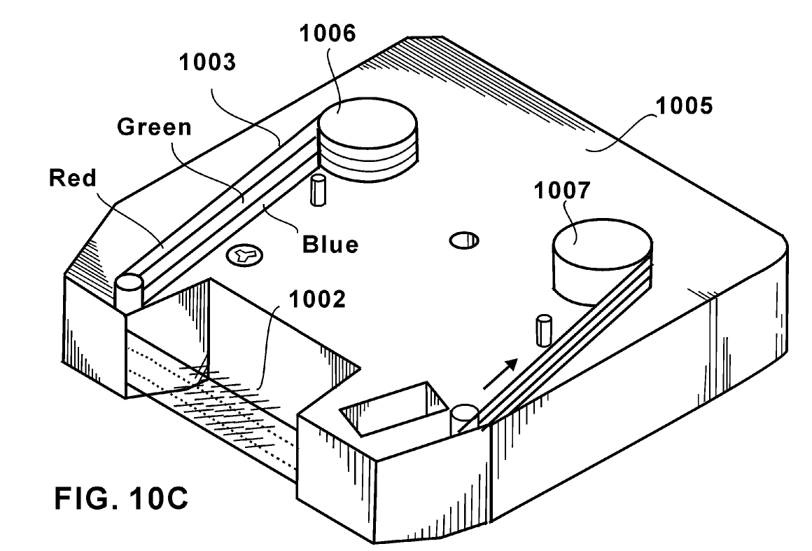

Referring to the schematic diagram in FIG. 10A illustrating a print head 1001 comprising (a) three sets of wires 1002 with sequential variation in diameter arranging in a 3×8 matrix and (b) solenoids (not shown) having variable driving current. Now the print wires 1002 with smooth and conical surface at the tips are activated to strike onto the printing substrate via the ribbon of transferable foil 1003. The ribbon and the print wire are aligned parallel to each other so as to allow the set of print wire to strike onto the respective color on the ribbon. For each printing stroke the ribbon is advanced forward for a distance at least equal to the amount covered by the 8 pieces of print wire. This arrangement is to avoid stamping on the used location of the foil repeatedly.

FIG. 10B shows an enlarge side view of the print wire 1002 having a conical profile at the tip 1004. This conical profile is essential to provide variation in dot size in the print. Namely for a larger impacting force applying to the wire as a resulting of a higher driving current in the solenoid, a larger indentation area will effect on the substrate and results in larger area of foil transfer. FIG. 10C illustrates an exposed view of the ribbon cassette 1005. The ribbon 1003 comprising a transferable foil of diffraction gratings in the form of a flexible web is initially wound round a supplying pool 1006 and is being advanced forward by a stepper motor (not shown) in synchronize with the printing stroke of the wires. After printing the used portion of the web of ribbon become a waste and is collected into a receiving pool 1007.

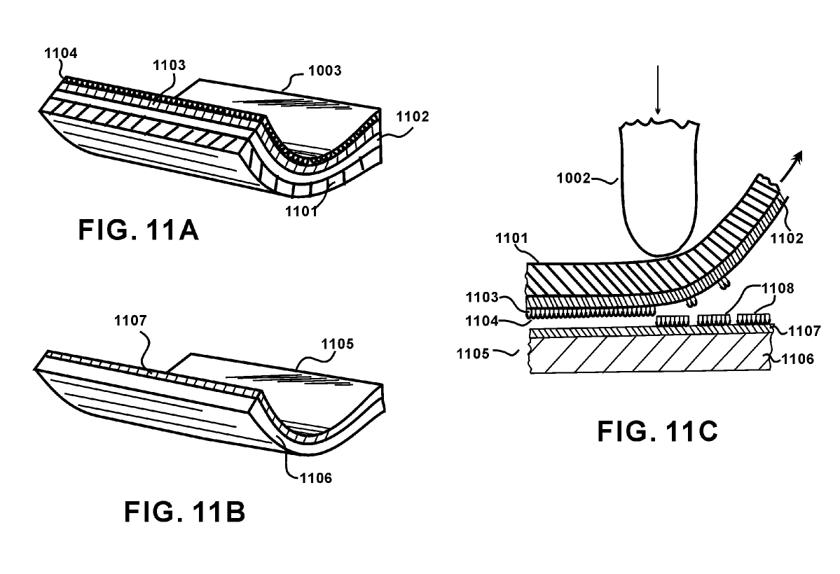

The three sections of color ribbon are manufactured employing the same optical apparatus shown in FIG. 5, in which the print wire in FIG. 5 is replaced by a glass plate that is coated with a thin layer of positive photoresist. The exposed plate is subsequently subjected to the full process of electroforming and embossing onto aluminized polyester hot-stamping foil. Referring now to FIG. 11A illustrating the enlarged cross-sectional structure of the transfer foil and the printing substrate. The transfer foil 1003 is made of standard hot-stamping foil material but without the adhesive coatings. It comprises a film laminated by a plurality of layer portions, namely, the carrier layer 1101, the release layer 1102, the protective lacquer layer 1103 and the reflecting aluminized layer 1104. The carrier layer is composed of a polyester film with a thickness between 10 and 25 micron and is designed to separate from the other layers to be disposed of as wastage after the application.

The separation between the PET layer and the lacquer layer is made easy by the release layer composes of Ester wax with a thickness of 0.1 micron. The lacquer layer 1103 is composed of MEK, Toluene, Cyclohexanone and Cellulose nitrate at a thickness of about 1.5 micron that is made to have a higher degree of brittleness so that it can separate cleanly at the edges from the non-transferred part of the material. This lacquer layer bears the surface relief pattern and its reflectivity is enhanced by a thin layer of aluminum that is applied onto the surface using methods of vacuum deposition.

According to another embodiment of the invention a printing substrate 1105 is provided as shown in the cross sectional diagram in FIG. 11B. It comprises a thin and transparent polyester foil 1106 of about 50 micron thick, with the topside coated with a thin layer 1107 of pressure-activated adhesive such as EVA. This adhesive is in the form of dry and non-tacky at room temperature, but becomes sticky under high temperature and pressure. This printing substrate 1105 is exactly the same type of material that is conventionally being used in laminating the identity cards and photos for protective purposes.

The mechanism of image transfer is explained in FIG. 11C. The striking force provided by the printing wire 1002 acts as a stamping machine to press the reflecting layer 1104 together with the lacquer layer 1103 of the ribbon onto the adhesive layer of the substrate material 1107 in a dot-by-dot basic. The adhesive, upon being activated by the striking force and heat of the wire, attracts a portion of the transfer foil to adhere to the substrate. The dots of transfer foil bearing the three primary colors of red green and blue are applied onto the substrate in register relationship in a manner corresponding to the color components of the image.

After the completion of the wire printing process the print substrate bearing the color image is finally laminated onto another substrate such as paper or polyester foil using a conventional laminating machine. The image is viewed from the backside of the substrate, which has become clear and transparent after the heating process of lamination. The background color of the image on the area where there is no wire printing action has taken place depends on the color of the final substrate to which the image is to be laminated on. For example if the final substrate is a piece of black paper then the background color of the image is black, which is a desirable option.

The diffractive optical elements employed in the present invention offers on one hand a distinctive means for printing color images using additive method, but on the other hand there associates with it an undesirable limitation in that the color thus created is rainbow in nature, namely the observed color may change across the entire range of the visible spectrum when the viewing angles change. That means the condition for faithfully reproducing a true color image is subjected to the satisfactory conformation with a set of pre-determined viewing parameters, which includes the extend of the illuminating light source and the viewing angle made between the observing eyes and the color prints, etc. Any significant deviation from this set of viewing parameters may result in the perception of faulty color. Two devices are therefore specifically invented to cope with this problem. These are the auxiliary illuminating device and the color control chart.

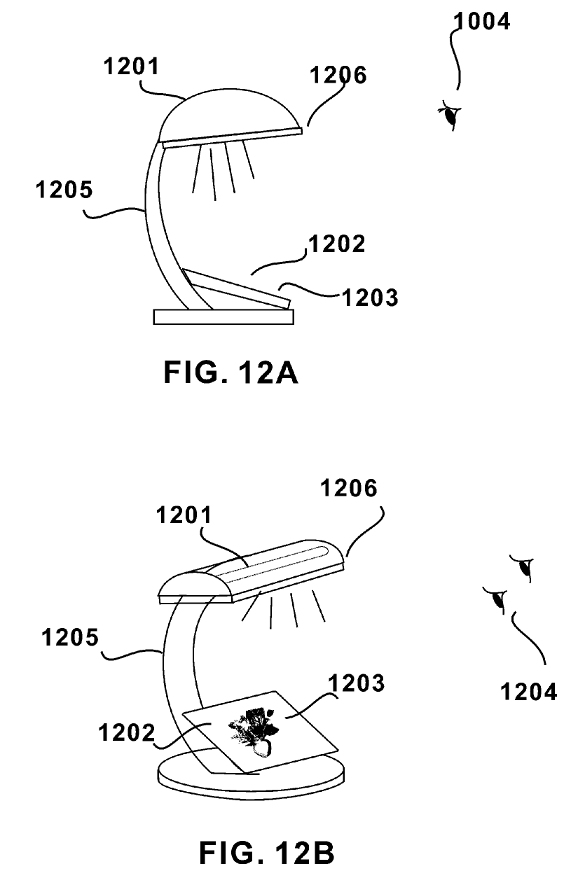

According to one embodiment of the invention there provides with an auxiliary illumination device that unified all the necessary viewing parameters into one single unit. FIG. 12A shows the side view and FIG. 12B the elevated view of the device comprising an inclinable viewing platform 1202 and a fluorescent light tube 1201. The latter has a length at least twice the width of the color print to be viewed and is supported via a strong but flexible arm 1205 to allow for fine adjustment to the angle of illumination. A diffuser 1206 such as a piece of ground glass is placed in front of the light tube to enlarge the area of illumination. The color print 1203 produced by the additive color printer of the present invention is placed on top of the platform 1202. The two adjustable components are preset to provide appropriate viewing conditions for the observer 1204 to perceive the true color nature of the prints. With this device the problem of limited viewing angle associated with the diffractive optical element no longer exists, because the viewing angle is now dictated by the width of the fluorescent light tube. This is an optional device and should not be regarded as a limit to the degree of freedom in the implementation of the present invention.

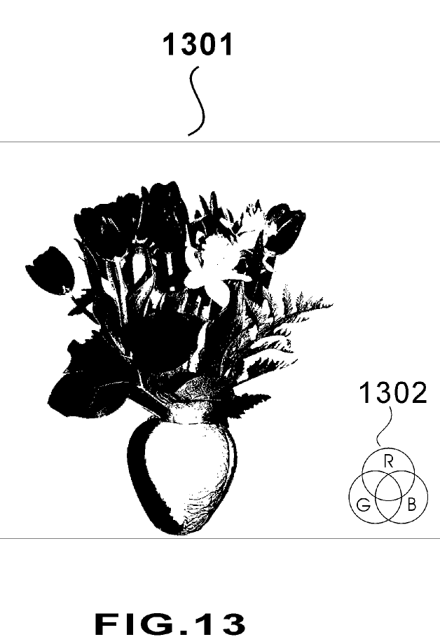

According to another embodiment of the present invention, there is provided with a color control chart comprising three mutually overlapping circular images of red green and blue. A schematic diagram of this control chart is shown in FIG. 13. Each circle has a diameter of at least 8 mm. The control chart is being printed at the corner of the additive color image 1301. The circular images 1302 are arranged in a triangular format and at least half of the area in each circle is overlapping to other ones. The area where all three circles overlap will appear as white color. This device provides a means to the viewer for optimizing the viewing configuration so as to achieve the goal of faithful reproduction of the true color effect. The viewer may search for the most appropriate viewing angle by adjusting his/her viewing position with respective to the illuminating light with the guidance of this color chart until a set of three primary color of red, green and blue is perceived.

Having described and illustrated the mechanism of the technology with reference to specific implementations it will be recognized that the above detailed embodiments are exemplary only. The technology can be implemented in many other different forms, for example:
(a) The cross-sectional geometry of the wires tip may take the shape of an ellipse or a rectangle to optimize the effective area of the print image, which in turn affect the brightness of the image.
(b) A plurality of print heads each having different dimension in the wire tips can be installed into one single wire printer to produce dots with large variety of diameter so as to print out full color images having different resolution and gray scales within an optimal time.
(c) While a reflection mode of additive color printing has been introduced herein, the principle of the invention is equally applicable to transmission mode by using similar substrate materials but of transparent nature.
(d) The same set of printing wires can be installed into other mode of printing machine, i.e. the graph plotters such as the Hewlett Packard 7475A and Graphtec MP5300 to achieve the same result of additive color printing. Of course the plotting mode using dots instead of lines is to be selected in executing the present printing operation.
(e) It is found that heat may not be a necessary factor contributing to the embossing procedure because cold printing with the print head set at room temperature has been successful achieved using the apparatus disclosed herein.
(f) The art of incorporating the surface relief diffractive optical element into the wire tip may take an alternate mode by using electroforming technique. In this mode the diffractive optical element is first recorded onto a flat plate of photoresist. A metal shim of the first generation master is then produced. Subsequently a mask having plurality of tiny holes is coated onto the surface of the first metal master. After the second electroforming a plurality of tiny dots of nickel plates bearing the diffractive optical element at the surface are produced. Each dot may have a diameter as small as o.o5 mm. The tiny dots of nickel “printing shim” are finally embedded onto the tips of the wires using special adhesive, with the face bearing the surface relief pattern facing outwards. This provides an easier method for the production of print wires imprinted with relief pattern but the trade off is a shorter life span as the adhesive may not be holding the dot-shaped shim strong and long enough to survive the shear amount of impacting force and billions of printing cycles.
(g) The latest technology of e-beam engraving can be employed to make the high diffraction efficiency optical element at the wire tip.
(h) Using the same concept of this invention, a manual type of additive color drawing system can be obtained. This is done by placing a piece of metallic printing shim bearing the surface relief diffractive pattern over an aluminized PET foil or polycarbonate board, with the surface relief side of the shim making direct contact with the aluminized surface of the PET foil or the polycarbonate. Then by using a ball pen or any wire-like object such as a piece of wooden stick to draw or write at the backside of the shim, the diffractive pattern can be impressed and transferred onto the thermal plastic substrate.
(i) An alternate approach is also viable by placing a piece of transfer foil bearing diffractive transferable pattern on top of the substrate coated with pressure-activated adhesive. Again the mechanism of image transfer can be performed by writing or drawing at the backside of the transfer foil using a ball pen or pencil. In so doing the three colors may be overlapping to each other in some area. It is obvious that the bottom layer of foil will be the only color to be seen in that area as the final image after laminating is viewed from the backside of this print substrate.
(j) By using wires having various angles of diffractive optical elements, the wire printer embodying the present invention can perform stereographic images with 3D nature.

It should be appreciated by those skilled in the art that the descriptions disclosed above represent techniques discovered by the inventor to function well and thus can be considered to constitute exemplary modes for its practice. However, those with skills in the art will, judge from the present presentation, appreciate that many changes can be made in the specific embodiments which are disclosed and still obtain a similar or like result without departing from the scope and spirit of the invention

1. A desktop computer printer for printing additive color image comprising:
(a) a conventional wire printer with modification wherein said modification includes at least four major areas to replace standard component parts and functions; and
(b) a microprocessor to coordinate the printing process.

2. The four areas of modification as claim in claim 1,
Wherein said first modification includes the removable of the print cassette and ink ribbon from said conventional wire printer;
Wherein said second area of modification includes the use of print wires having surface relief diffraction gratings etched at the wire tips;
Wherein said third area of modification includes the replacement of the rubber platen by one made of polished hard steel and
Wherein said forth area of modification includes the use of thermoplastic materials as printing substrate instead of paper.

3. The print wire as claim in claim 2,
Wherein said diffraction gratings at said wire tips have line frequencies of 800, 1000 and 1200 line-pair per millimeter, corresponding to diffraction spectra of red green and blue color, respectively;
Wherein said diffraction gratings on each wire are orientated at similar angle with respective to the advancing direction of said print substrate and
Wherein said diffraction grating has an orientation with its zero value defined as the direction of the advance movement of the print substrate.

4. The print wire as claim as claim 2,
Wherein said surface relief diffraction gratings are made by coating with a photoresist layer at the wire tip, exposing by laser light under a standard two-beam interference configuration and then developing chemically using NaOH and
Wherein said surface relief pattern is etched onto the wire tip via the technique of ion mill etching processes.

5. The print wire as claim in claim 2,
Wherein said print wires have sequential variation in diameters;
Wherein said print wires have conical surface profile at the tips and
Wherein said print wires are driven by solenoids with variable force.

6. The print substrate as claim in claim 2,
Wherein said thermoplastic material is an aluminized polyester foil of at least 30 micron thick and
Wherein said thermoplastic material is a board of polycarbonate with at least 0.3 mm thick and with a thin coating of reflecting silver layer on the printed side.

7. The desktop additive color printer as claim in claim 1, wherein said microprocessor is programmed to coordinate the striking sequence of said wires, to coordinate the X movement of said printing head and the advance movement of said substrate so as to print out an additive color image in accordance with the data of the digital camera.

8. A printing system for use in the publishing industry that is capable of providing mass production of additive color pictures comprising:
(a) a mastering system for making print master;
(b) a standard embossed hologram printing system including electroforming facilities and embossing machines for printing embossed hologram using hot-stamping aluminized polyester foil and
(c) a hot-stamp printing machine.

9. The mastering system as claim in claim 8,
Wherein said print master is made using the additive color printer as set forth in claim 1;
Wherein said wire printer of said additive color printer is preferable a flatbed type and
Wherein said master is made using a substrate of thin polycarbonate board having a thickness of at least 0.3 mm.

10. A desktop computer printer for printing additive color images comprises:
(a) a conventional wire printer with at least three major areas of modification to replace the standard component parts and
(b) a microprocessor to coordinate the printing process.

11. The additive color printer as claim in claim 10,
Wherein said first modification to a conventional wire printer includes use of a set of special wires,
Wherein said print wire have sequential variation in diameters;
Wherein said print wires have conical surface profile at the tips and
Wherein said print wires are driven by solenoids with variable force.

12. The additive color printer as claim in claim 10,
Wherein said second modification to a conventional wire printer includes replacing the ink ribbon by a ribbon made of transferable foil that is pre-embossed with surface relief diffraction gratings.

13. The transferable ribbon as claim in claim 12,
Wherein said material is made of conventional hot-stamping material but without being coated with adhesive and
Wherein said ribbon comprises three files of transferable foil embossed with diffraction gratings having different pitches corresponding to the red green and blue colors.

14. The additive color printer as claim in claim 10,wherein said third modification to a conventional wire printer includes the use of a print substrate made of plastic film with smooth surface.

15. The print substrate as claim in claim 14,
Wherein said plastic film is a polyester foil of at least 80 micron thick and
Wherein said print substrate has a surface coated with a thin layer of pressure activated adhesive such as EVA or pressure sensitive adhesive.

16. The additive color printer as claim in claim 10 wherein said microprocessor is programmed to select the striking sequence of said wires with respective to the color of said transferable ribbon, to coordinate the X movement of said printing head and the advance movement of said substrate, so as to print out an additive color image in accordance with the data of the digital camera.

17. An illuminating device for providing proper viewing of the additive color image comprising:
(a) a fluorescent light tube with diffuser at the front;
(b) an inclinable image platform for mounting the prints, and
(c) a flexible supporting arm for the light tube.

18. The illuminating device as claim in claim 17,
Wherein the angle between the observer, said image platform and the angulations of said light tube are set to provide true color perception to the color prints;
Wherein the length of the fluorescent light tube is at least twice the width of the color prints and
Wherein the longitudinal direction of the fluorescent light tube is aligned to parallel with the lateral direction of the color print.

19. A control color chart for the guidance of correct viewing configuration of the prints comprising a color image of three circles printed at the corner of each print using the printer as set forth in claim 1 and claim 10.

20. The control color chart as claim in claim 19,
Wherein each circular image is at least 8 mm in diameter;
Wherein the three circular images corresponding to the three primary color of red green and blue;
Wherein the three circular color images are arranged in a triangle format;
Wherein at least half of each circles overlap to each other and
Wherein the dots of diffraction grating in the overlapping area are exclusive from each other in position.
